(19) United States
(12) Patent Application Publication
(10) Pub. No.: US 2007/0261642 A1
(43) Pub. Date: Nov. 15, 2007

(54) Housing for gerbils and like pets

(76) Inventors: Seth L. Neubardt, Mamaroneck, NY (US); Carl A. Neubardt, Mamaroneck, NY (US)

Correspondence Address: LAW OFFICE OF LEO ZUCKER, 25 BANK STREET, SUITE 212-K, PO BOX 1194, WHITE PLAINS, NY, 10602-1194, US

(21) Appl. No.: 11/433,263

(22) Filed: May 12, 2006

(51) Int. Cl. A01K 1/03; A01K 39/01

(52) U.S. Cl. 119/479; 119/454

(57) ABSTRACT

A method of housing a gerbil or like pet. Sections of cardboard are formed into a first housing structure for the pet, and the structure is placed in a container whose walls are transparent or have openings through which the container's interior can be viewed. The container is closed after placing the pet in the housing structure, and pieces of the cardboard sections start to accumulate at the bottom of the container as the pet chews on the sections. Some of the chewed pieces form bedding for the pet while other pieces absorb pet waste. Once the housing structure is substantially chewed into pieces, the container is opened and the chewed pieces are removed. A second housing structure formed of cardboard sections is placed in the container, and the container is closed after the pet is placed in the second housing structure.

### BACKGROUND OF THE INVENTION

1. Field of the Invention

This invention concerns enclosures for small animals or pets such as gerbils.

2. Discussion of the Known Art

U.S. Pat. No. 6,684,817 (Feb. 3, 2004) discloses a nest-forming structure and breeding house for small animals such as hamsters. The house is constructed of layers of cardboard in which nest spaces and passages are cut out, and the house is surrounded by a main casing having a transparent front panel. According to the patent, rodents will move about the nest spaces and obtain nest forming materials by gnawing at the cardboard that forms the nest spaces. See also U.S. Pat. No. 4,391,223 (Jul. 5, 1983) which describes a cardboard house for pets generally, and U.S. Pat. No. 6,584,934 (Jul. 1, 2003) which shows a habitat made of biodegradable and chewable material for nesting rodents.

U.S. Pat. No. 5,975,908 (Nov. 2, 1999) describes a method and kit for constructing a scale model of, inter alia, a doll house by using a computer to visualize a number of different sections of the house, and then printing two-dimensional outlines to serve as templates for cutting pieces of flat stock from which the house is assembled. The '908 patent does not suggest the construction of housing for small pets such as gerbils, however.

### SUMMARY OF THE INVENTION

According to the invention, a method of housing a gerbil or like pet includes providing a container having side walls at least some of which are transparent or have openings through which an interior region of the container can be viewed. One or more sections of cardboard are formed into a first housing structure for the pet, and the structure is placed in the container. The container is closed after placing the pet in the housing structure, thus preventing the pet from escaping the interior region of the container. Pieces of the cardboard sections accumulate at the bottom of the container as the pet chews on the sections, with some of the chewed pieces forming bedding for the pet and other pieces absorbing waste from the pet.

Once the pet substantially chews the first housing structure into pieces, the container is opened and the chewed pieces are emptied from the container. One or more sections of corrugated cardboard are formed into a second housing structure which is placed inside the emptied container, and the container is closed after the pet is placed in the second housing structure.

For a better understanding of the invention, reference is made to the following description taken in conjunction with the accompanying drawing and the appended claims.

### BRIEF DESCRIPTION OF THE DRAWING

In the drawing:

FIG. 1 shows a cage serving as a container for a hat housing structure, and sections of cardboard been prepared to form the housing structure;

FIG. 2 shows the cardboard sections forming the housing structure, and a cardboard staircase to be glued inside the structure;

FIG. 3 shows the housing structure placed inside the cage container in FIG. 1;

FIG. 4 shows a gerbil inside the housing structure after chewing away portions of the structure;

FIG. 5 shows the gerbil at the bottom of the cage container after the housing structure is substantially chewed away; and

FIG. 6 is a flow chart of the inventive process.

### DETAILED DESCRIPTION OF THE INVENTION

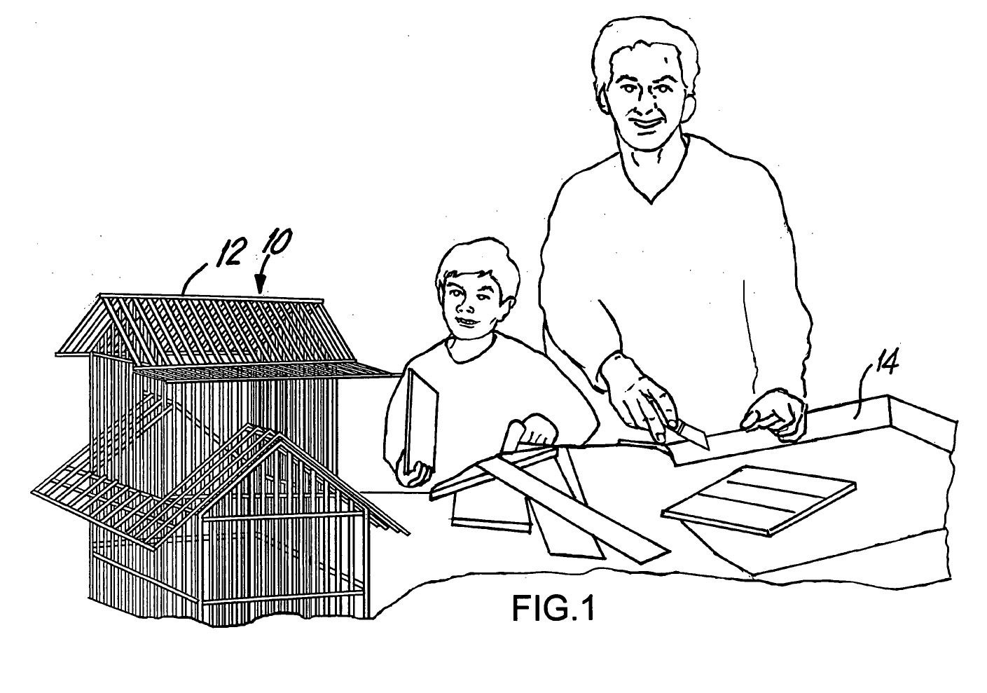

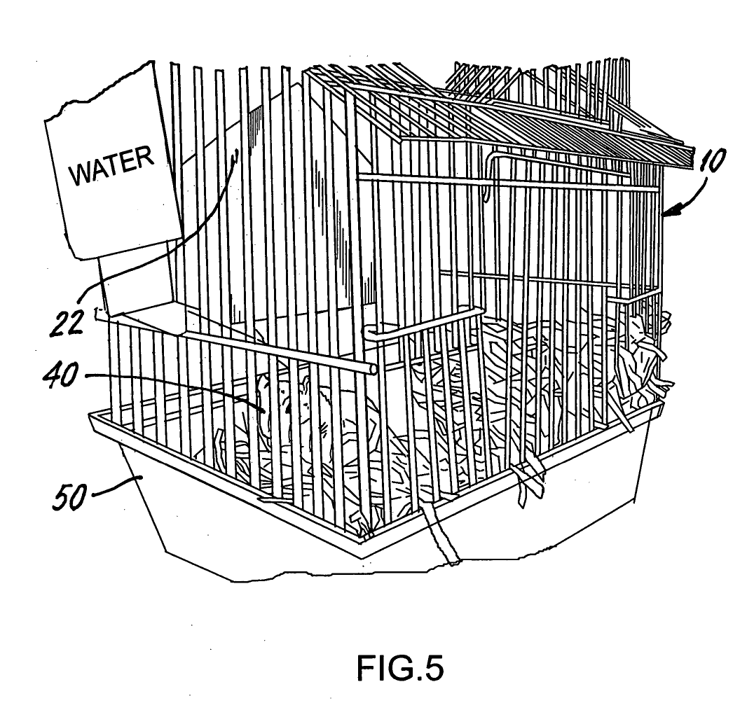

FIG. 1 shows a container 10 in the form of a bird cage. Alternatively, the container 10 may comprise a fish tank, an ordinary hamster cage, or other enclosure having side walls at least some of which are transparent or have openings through which an interior region of the container can be viewed from outside. The container 10 in FIG. 1 has a top roof portion 12 that can be removed for access to the interior of the container. Further, the container 10 preferably has a detachable base or bottom portion which is shown in FIG. 5 and described further below.

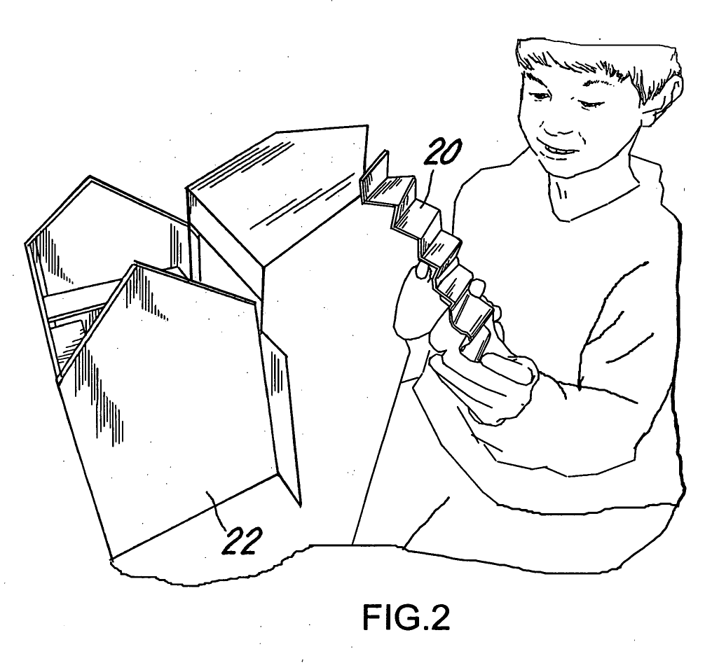

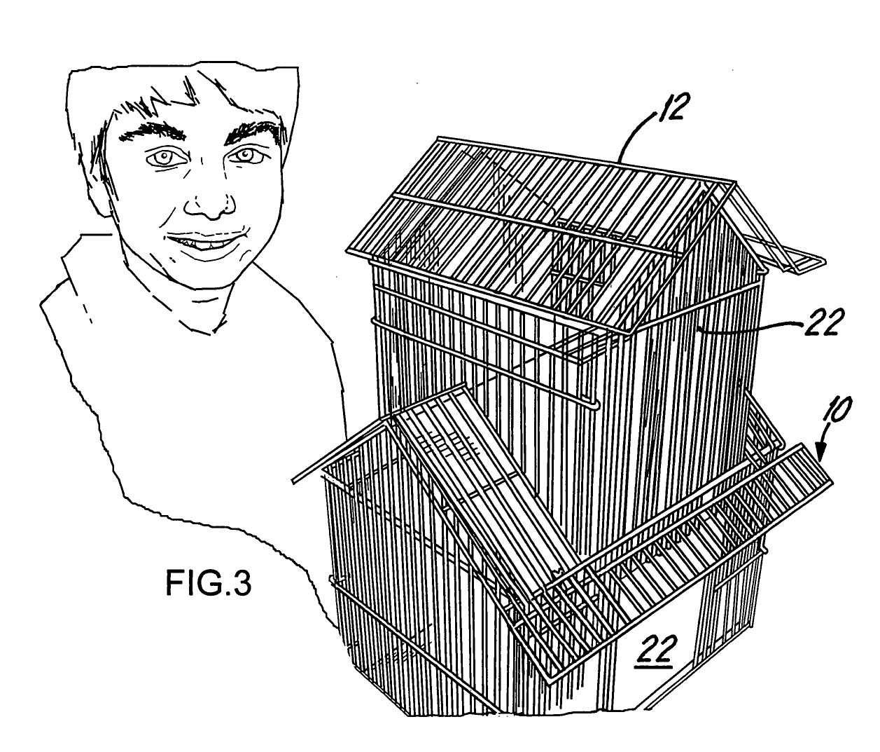

As seen at the right in FIG. 1, a sheet of corrugated cardboard 14 is being cut into a number of panels or sections having such dimensions as to form a housing structure for a gerbil or like small pet. As seen in FIGS. 2 and 3, the sections may form side walls and roofing for the structure. The cardboard 14 may be obtained from conventional shipping or storage boxes. A single layer of corrugated raw cardboard is preferred, without any glossy or printed paper covering as sometimes adhered to the exterior of cardboard boxes containing products such as toasters or other appliances. The cardboard sections preferably should have exposed thin edges that are approximately 1 to 2 mm thick.

FIG. 2 shows a cardboard section that has been folded into the form of a staircase 20. Glue is applied on side edges of the staircase 20, and the staircase is set between levels of a nearly completed housing structure 22 shown at the left in FIG. 2. When placed inside the housing structure, a gerbil or other small pet may use the staircase to reach different levels of the structure. Children as well as adults can use their imagination to form various internal fixtures or compartments within the housing structure 22, thus making the construction and assembly of the structure fun for persons of all ages. For example, obstacle courses may be defined knowing that gerbils will typically attempt to “figure out” such courses. A food treat may be placed at the end of an obstacle course, or such a treat may be placed in a closed cardboard compartment that may be chewed open. A conventional spring-loaded flag mechanism may be arranged to “pop up” once the mechanism senses that the gerbil has chewed through the food compartment, thus signaling that the gerbil has reached the treat. Two gerbils may also be placed in the housing structure and at opposite ends of the structure, and “bets” may be taken as to which gerbil will chew its way first to the center of the structure.

FIG. 3 shows the assembled housing structure 22 placed inside the container 10. For example, the roof portion 12 of the container may be removed or swung aside, and the structure 22 lowered into the container 10 after a gerbil or other small pet is placed inside the structure 22. Alternatively, a bottom tray (see FIG. 5) of the container may be withdrawn, and the remaining upper portion of the container 10 lowered over the housing structure 22 after the structure is set on the tray. Those cardboard sections that form outer walls of the structure 22 are aligned with respect to corresponding walls of the container. In the illustrated embodiment, the outer walls and roofs of the housing structure 22 are dimensioned and arranged to conform in size and shape with the outer walls and roofs of the container 10. It is not, however, essential for the assembled housing structure 22 to align precisely with all inside surfaces of the container 10.

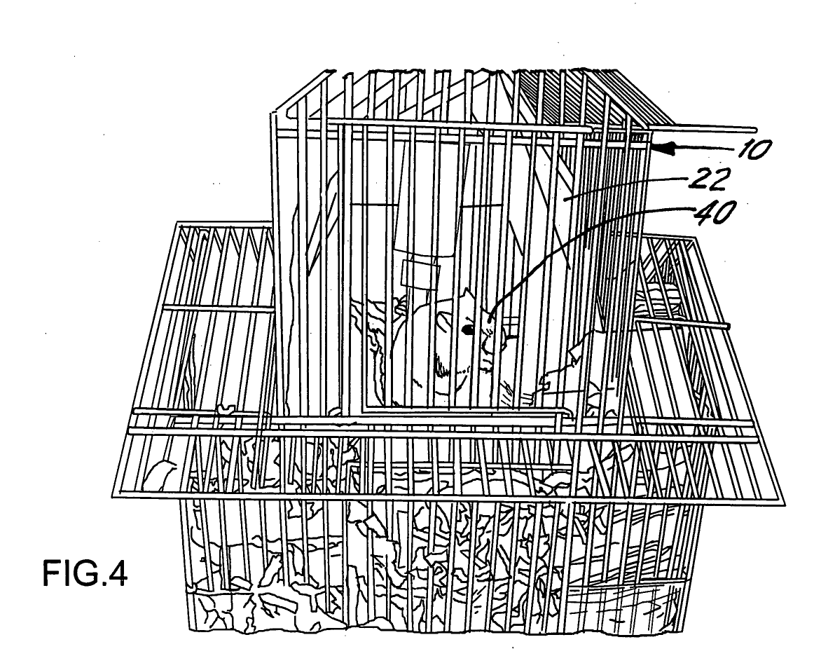

FIG. 4 shows a gerbil 40 inside the housing structure 22, several days after the gerbil has been placed in the structure 22 and has chewed away portions of the structure. FIG. 5 shows the gerbil 40 inside the structure 22 after approximately 20 days. The housing structure 22 has been substantially chewed away by the gerbil. Chewed pieces of the structure descend toward the bottom of the container 10, and accumulate in a removable bottom tray 50 of the container. It has been observed that the gerbil 40 will use some of the chewed pieces as bedding, while other pieces act to absorb waste from the gerbil. Once the outer walls of the housing structure 22 and any interior components or structures (e.g., food compartments, staircases or the like) are substantially chewed into pieces, the container 10 is preferably opened by separating the tray 50 from the container and emptying the accumulated chewed pieces from the tray. The tray 50 and the remainder of the container 10 may then be washed or cleaned as desired. A replacement housing structure 22 formed of one or more cardboard sections may be aligned inside the container 10 and the container then closed, as described above, after the gerbil is placed inside the replacement structure.

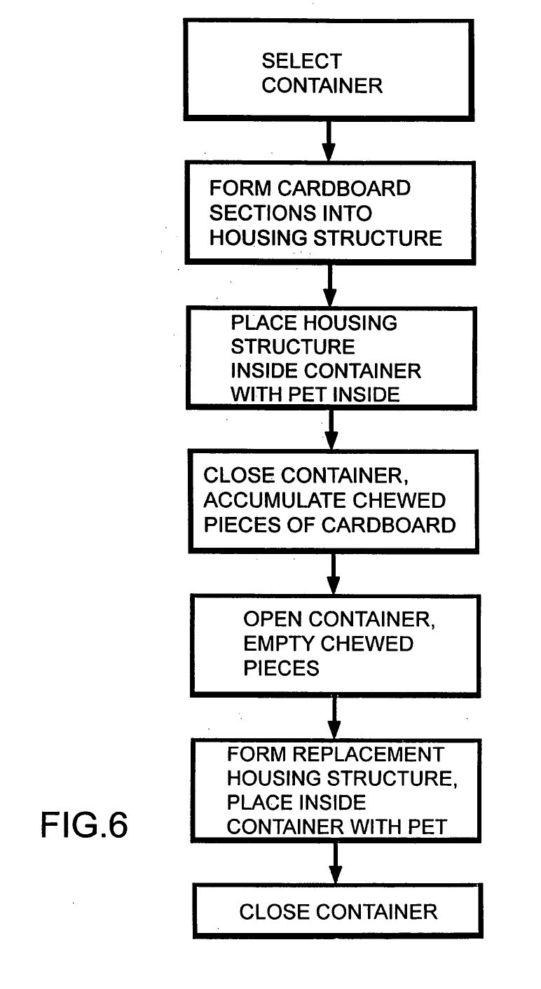

The inventive process is shown in FIG. 6 and involves the assembly of a cardboard structure for housing a gerbil or other small pet. The structure may have interior rooms, closed food compartments, staircases and other components in a desired layout. The structure is placed within a container such as a cage or fish tank whose walls allow viewing of the interior of the container from outside. Children as well as adults may be amused by watching their pet(s) chew away at walls and other parts of the structure to reach hidden food treats. Some of the chewed pieces of the structure are used as bedding by the pet while other pieces act to absorb pet waste.

The whole process is advantageous because while the gerbil chews happily away at the housing structure, and children (as well as their parents) happily watch, lots of bedding material is being created thus saving the expense of buying separate chips. It has been found that the gerbil 40 creates its own bedding at at least the same rate that the gerbil soils it, so fresh clean bedding is available each day. When the housing structure is substantially chewed down, the chewed pieces are dumped from the container tray and a replacement housing structure is set in place. The time for the gerbil 40 to chew down the housing structure 22 shown in the drawing, may take about one month. During this time, children and/or their parents may design and assemble a larger and more complex housing structure to replace the previous structure. For example, a computer program may be used to develop layouts and floor plans for the housing structures, and to output dimensions for cardboard sections needed to form the structures.

While the foregoing represents preferred embodiments of the invention, it will be understood by those skilled in the art that various modifications and changes may be made without departing from the spirit and scope of the invention, and that the invention includes all such modifications and changes as come within the scope of the following appended claims.

We claim:

1. A method of housing a gerbil or like small pet, comprising:
providing a container having side walls at least some of which are transparent or have openings through which an interior region of the container can be viewed;
forming one or more sections of cardboard into a first housing structure for the pet;
placing the housing structure in the interior region of the container;
closing the container after placing the pet inside the housing structure;
accumulating pieces of the cardboard sections of the first housing structure at a bottom region of the container as the sections are chewed by the pet, with some of the chewed pieces forming bedding for the pet and other pieces acting to absorb waste from the pet;
opening the container after the first housing structure is substantially chewed into said pieces by the pet, and emptying the chewed pieces from the container;
forming one or more sections of cardboard into a second housing structure for the pet;
placing the second housing structure in the interior region of the emptied container; and
closing the container after placing the pet inside the second housing structure.

2. A method according to claim 1, including conforming the sections of cardboard dimensionally for alignment with corresponding inside surfaces of the container.

3. A method according to claim 1, including forming the cardboard sections of the housing structure with exposed edges that are approximately 1 to 2 mm thick.

4. A method according to claim 1, including selecting a cage for the container.

5. A method according to claim 1, including selecting a fish tank for the container.

6. A method according to claim 1, including forming a cardboard section into a staircase, and setting the staircase inside the housing structure.

7. A method according to claim 1, including defining an obstacle course for the pet inside the housing structure.

8. A method according to claim 1, including forming a cardboard section of the housing structure into a food compartment.

9. A method according to claim 8, including signaling when the gerbil chews through the food compartment.

10. A method according to claim 9, including arranging a flag to carry out the signaling step.
